(19) United States
(12) Patent Application Publication
(10) Pub. No.: US 2026/0161595 A1
(43) Pub. Date: Jun. 11, 2026

(54) APPARATUS WITH COMPRESSION INTERFACE AND METHODS FOR OPERATING THE SAME

(71) Applicant: Micron Technology, Inc., Boise, ID (US)

(72) Inventors: Chetan Chauhan, Folsom, CA (US); Raymond Chang, Sacramento, CA (US); Raghukiran Sreeramaneni, Frisco, TX (US); Nevil N. Gajera, Meridian, ID (US)

(21) Appl. No.: 19/358,713

(22) Filed: Oct. 15, 2025

Related U.S. Application Data
(60) Provisional application No. 63/729,082, filed on Dec. 6, 2024.

(51) Int. Cl. G06F 13/42; G06F 13/16; G06F 13/40

(52) U.S. Cl. CPC G06F 13/4234; G06F 13/1668; G06F 13/4068

(57) ABSTRACT

Methods, apparatuses, and systems related to a data converter that compresses and/or decompresses data on an interface die for communications with a processor are described. Operations of data converter may be further facilitated by a memory controller within the interface die.

### CROSS-REFERENCE TO RELATED APPLICATIONS

The present application claims priority to U.S. Provisional Patent Application No. 63/729,082, filed December 6, 2024, the disclosure of which is incorporated herein by reference in its entirety.

### TECHNICAL FIELD

The disclosed embodiments relate to devices, and, in particular, to semiconductor memory devices with a circuit interface fabric and methods for operating the same.

### BACKGROUND

An apparatus (e.g., a processor, a memory system, and/or other electronic apparatus) can include one or more semiconductor circuits configured to store and/or process information. For example, the apparatus can include a memory device, such as a volatile memory device, a non-volatile memory device, or a combination device. Memory devices, such as dynamic random-access memory (DRAM), can utilize electrical energy to store and access data.

With technological advancements in embedded systems and increasing applications, the market is continuously looking for faster, more efficient, and smaller devices. To meet the market demands, the semiconductor devices are being pushed to the limit with various improvements. Improving devices, generally, may include increasing circuit density, increasing operating speeds or otherwise reducing operational latency, increasing reliability, increasing data retention, increasing functionalities, reducing power consumption, or reducing manufacturing costs, among other metrics.

### BRIEF DESCRIPTION OF THE DRAWINGS

FIG. 1A is a cross-sectional view of an example system-in-package (SiP) device.

FIG. 1B is a schematic block diagram of a processor and a memory device.

FIG. 1C is a circuit diagram of the processor and the memory device.

FIG. 2A is a cross-sectional view of a SiP device in accordance with an embodiment of the present technology.

FIG. 2B is a schematic block diagram of a processor and a memory device in accordance with an embodiment of the present technology.

FIG. 2C is a detailed circuit diagram of data converter circuitry in accordance with an embodiment of the present technology.

FIG. 3A is a flow diagram illustrating an example method of manufacturing an apparatus in accordance with an embodiment of the present technology.

FIG. 3B is a flow diagram illustrating an example method of operating an apparatus in accordance with an embodiment of the present technology.

FIG. 4 is a schematic view of a system that includes an apparatus in accordance with an embodiment of the present technology.

### DETAILED DESCRIPTION

As described in greater detail below, the technology disclosed herein relates to an apparatus, such as for memory systems, systems with memory devices, related methods, etc., for selectively communicating compressed data between the memory device and the corresponding host/processor. For example, the apparatus can include a High-Bandwidth Memory (HBM) device that includes one or more core dies stacked on an interface die. The interface die can include a circuit interface fabric that facilitates communication between a locally implemented memory controller (e.g., residing on/within the interface die) and the inter-die connections (e.g., Through Silicon Vias (TSVs)) that communicatively couple the core dies to the interface die. The interface die can further include a data converter circuit configured to selectively convert communicated data into compressed and uncompressed formats for communication with the processor.

As an illustrative example, the processor can compress the content data for a write operation and the communicate the compressed data to the memory device. The memory device can receive the compressed write data at the interface die and then generate and store the decompressed result. Similarly, for read operation, the memory device can obtain the read data and compress it at the interface die. The memory device can send the compressed read data to the processor, and the processor can locally perform the decompression operation on the received compressed data. In compressing the data, the processor and/or the memory device can evaluate an amount of compression (e.g., a compression rate or ratio) achieved by the process. The processor and/or the memory device when the amount of compression satisfies a minimum threshold. Otherwise, if the payload data cannot be compressed by a sufficient amount, the devices can communicate the uncompressed or raw data. The communicating device can further send or include an indicator that identifies whether the payload data is in a compressed format or an uncompressed format.

Accordingly, the data converter circuit can allow the processor and the memory device, such as the HBM, to reduce the bandwidth (e.g., by about a factor of two or higher) required for the communications. The data converter circuit can further reduce the thermal density associated with the communication, such as by reducing the bandwidth and by reducing the refresh rate required for the HBM. Further, the data converter circuit can provide adjustable thresholds for evaluating the sufficiency of the compression for communication, thereby allowing the memory device and/or the processor to balance latency and compression priority according to context and need.

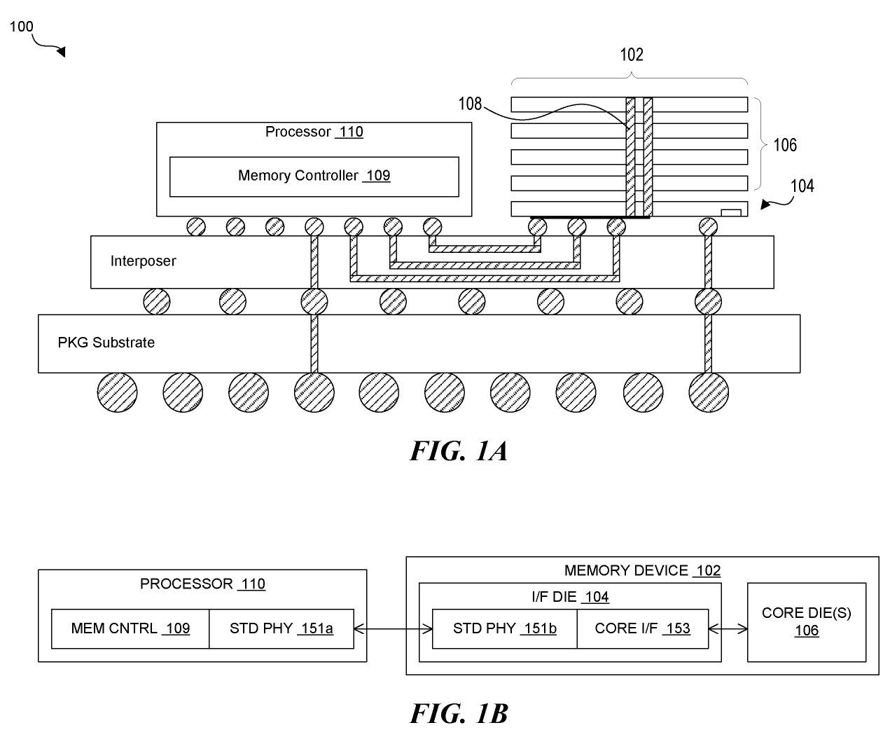

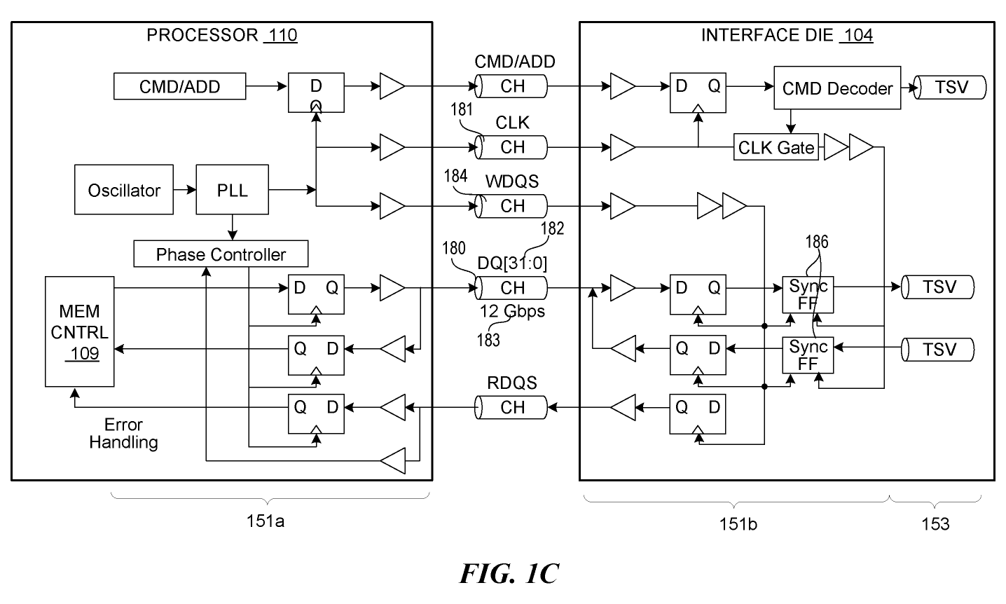

For context, conventional computing devices (e.g., a System-In-Package (SiP) devices) have the memory controller within a processor. FIG. 1 illustrates a schematic cross-sectional view of a SiP device 100. The SiP 100 can include a memory device 102 and a processor 110 (e.g., a central processing unit (CPU), a graphics processing unit (GPU), or the like), which are packaged together on a package substrate along with an interposer. The processor 110 may act as a host device of the SiP 100.

In some embodiments, the memory device 102 may be a HBM device that includes an interface die (or logic die) 104 and one or more memory core dies 106 stacked on the interface die 104. The memory core dies 106 can include DRAM devices/dies, NAND devices/dies, and/or other types of memory devices (e.g., static RAM (SRAM)) as main memory configured to store data provided by the processor 110 and to provide access of the stored data to the processor 110. The memory device 102 can further include additional and/or supplementary memory circuits (e.g., SRAM, DRAM, NAND, etc.), located within and/or outside of the core dies 106, configured for internal uses (e.g., remaining inaccessible to the processor 110). The memory device 102 can include one or more through silicon vias (TSVs) 108, which may be used to couple the interface die 104 and the core dies 106.

The processor 110 can further include a memory controller 109. In other words, the memory controller 109 can be external to the memory device 102 and be implemented as circuitry within the same package as the processor 110. The memory controller 109 can include a circuit configured to control and manage the flow of data going to and from the memory device 102 and the processor 110. The memory controller 109 can manage memory mappings, such as between virtual and physical addresses, and perform the corresponding translations. Accordingly, the memory controller 109 can issue commands, such as reads, memory management functions (e.g., refresh), and/or the like, to the memory device 102 using the physical memory addresses. Moreover, the memory controller 109 can map the read data into virtual addresses so that the processor 110 can operate on the requested data (e.g., according to the virtual addresses).

Illustrating additional details of the memory controller 109, FIG. 1B is a schematic block diagram of a processor (e.g., the processor 110) and a memory device (e.g., the memory device 102). The processor 110 can include a physical layer (PHY) interface circuit 151a, such as transmitters, receivers, signal drivers, and/or the like, configured to facilitate the exchange of electrical signals with the memory device 102. The PHY 151a can be coupled to and controlled by the memory controller 109. For the SiP 100 (e.g., Artificial Intelligence (AI) processing devices) including the HBM, the PHY 151a can be configured according to Joint Electron Device Engineering Council (JEDEC) standards regarding HBM communications.

The PHY 151a can be coupled to the memory device 102 and the interface die 104 therein using channels or similar connections within the interposer. The interface die 104 can include a PHY circuit 151b that implements the communications for the memory device 102. Accordingly, the PHY 151b can match or correspond to the PHY 151a. For example, the PHY 151b can be configured according to the JEDEC HBM standards.

Internally, the PHY 151a can be coupled to the core dies 106 through a core interface 153, such as the TSVs 108 of FIG. 1A. Accordingly, the PHY 151a can further manage the communications to and from the core dies 106.

As a further detailed example, FIG. 1C is a circuit diagram of the processor 110 and the memory device 102 (e.g., the interface die 104 therein). The PHY 151a of FIG. 1B can correspond to the flip flops and the drivers, the phase-locked loop (PLL) circuit, the phase controller, and/or the oscillator in the processor 110.

The memory controller 109 (e.g., the DRAM controller) can provide the write data to the PHY 151a along with a corresponding command and address (CMD/ADD). The command and address can be communicated through corresponding channel(s) to a receiver circuit within the PHY 151b of the interface die 104. The PLL can provide a corresponding clock (CLK) 181 used to read the bits/transitions within the command and addresses. Further, the PLL and the Phase controller can provide a timing signal internal to the PHY 151a for driving the data (e.g., DQ) outputs, such as the data/payload targeted for the write. Using the timing signal, the PHY 151a can drive and send the write data over DQ channel(s) a DQ bus 180 to the PHY 151b of the interface die. In coordinating the communication/timing of the data, the PLL can further provide a write data strobe signal (WDQS) over corresponding channel(s) 184.

As described above, the PHY 151b can receive the command and address and the payload data associated with the write command. The PHY 151b can further receive the timing signals, such as the CLK and the WDQS. The PHY 151b can include receivers, flip flops, gates, decoders, and the like configured to receive and process the write command and data according to the timing signals. The command decoder can be configured to identify the physical location, such as the chip/core die indicated by the address and the location within the die (e.g., channel, bank, row, column, and/or the like). The command decoder can provide the corresponding notification (e.g., enable, address communication, and/or the like) to the targeted core die through corresponding TSV(s). The command decoder can further control and enable the receiver circuitry to receive the write data. The write data can be provided to the targeted die through corresponding TSV(s), and the targeted die can perform the internal operations to write the data at the commanded address. In internally communicating the write data, the PHY 151b can include synchronizing flip flops 186 configured to synchronize and align the WDQS with the CLK.

For read commands, the memory controller 109 can provide the read command and the targeted addresses similarly as for the write. The memory controller 109 can effectively trigger the PLL to provide the timing signals as described for the write.

In providing the read data back to the processor 110, the PHY 151b in the interface die can identify the targeted die and location within the targeted die, and the corresponding die can read back the information from the commanded location. The read data can be provided from the targeted core die to the interface die through corresponding TSVs. The PHY 151b can use the WDQS to time the communication of the read data and further provide a read data strobe signal (RDQS) over corresponding channel(s) to the PHY 151a. The synchronizing flip flops 186 can perform the alignment for the read data similarly as the write data.

The read data can be provided over the same channel(s) (e.g., the DQ bus 180 having a bus width 182 of [31:0] bits at a communication speed 183 of 12 Gbps per JEDEC HBM) as the write data. Stated differently, the PHY 151a and the PHY 151b can be connected through a bi-directional data bus used to communicate both the read data (e.g., to the PHY 151a) and the write data (to the PHY 151b).

To process the read data, the PHY 151b can include a receiver and a corresponding circuit path different from those of the write circuitry. The read data can be received according to the RDQS signal and provided to the memory controller 109.

### Example Environment

In contrast to the conventional computing devices, embodiments of the present technology can include the circuit interface fabric that enables the implementation of the memory controller within the memory device. Moreover, based on having the controller at the memory device, the memory device and the processor can exchange or communicate compressed data. For example, the processor and the memory device can each have a converter that compresses and decompresses the data (e.g., the write data and the read data) for communication between the processor and the memory.

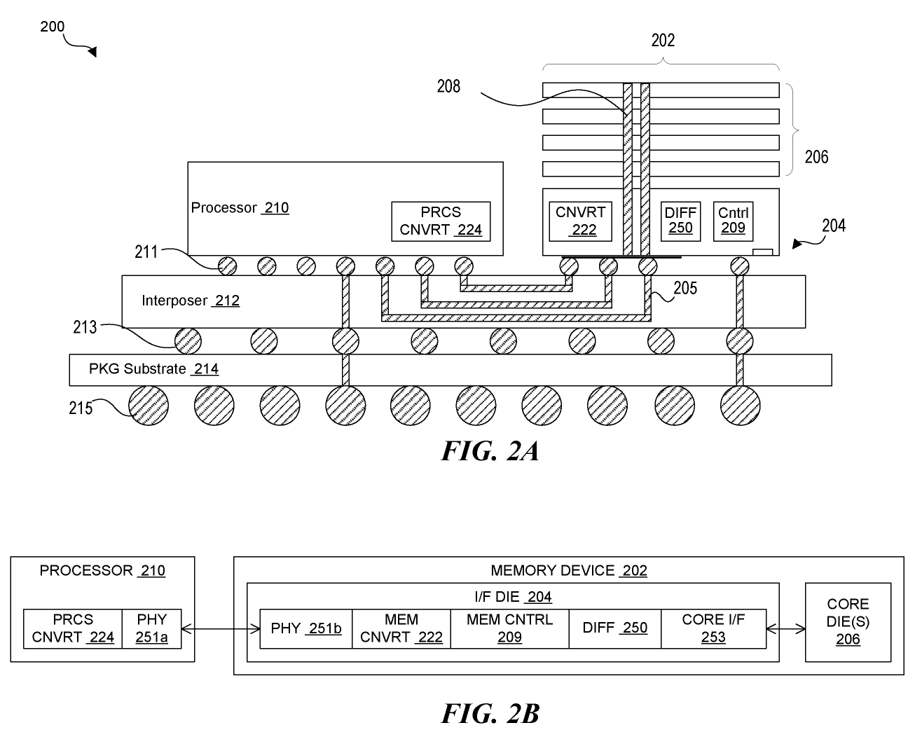

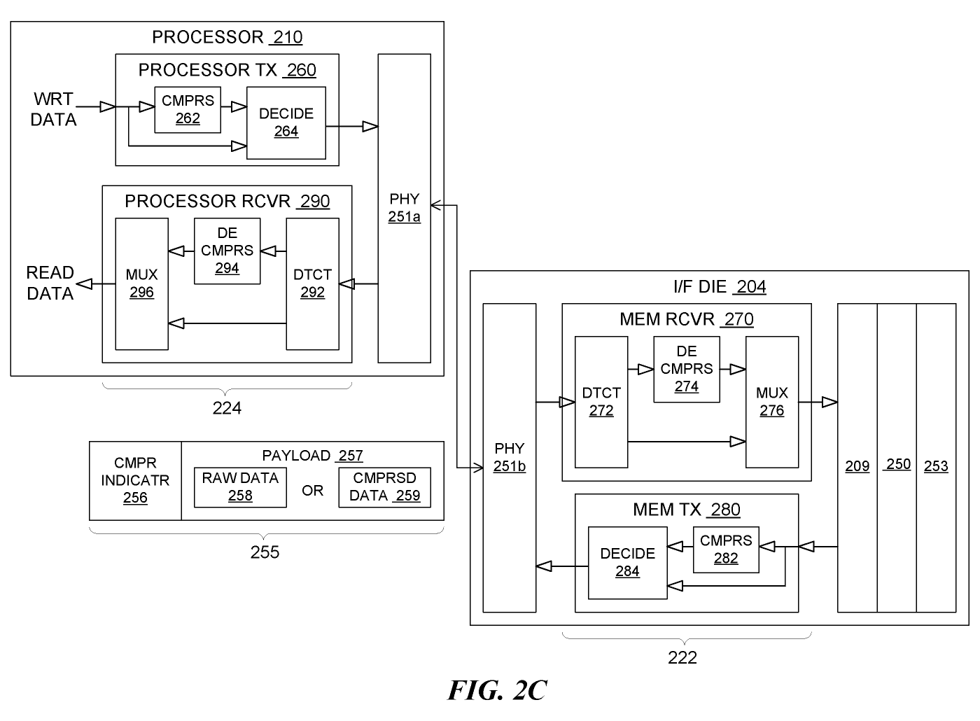

To illustrate the converter and the corresponding communication of compressed data, the FIG. 2A is a cross-sectional view of a system-in-package (SiP) device 200 (i.e., an example apparatus) in accordance with embodiments of the technology. The SiP 200 can include a memory device 202 and a processor 210 (e.g., a CPU, a GPU, or the like), which are packaged together on a package substrate 214 along with an interposer 212. The processor 210 may act as a host device of the SiP 200.

In some embodiments, the memory device 202 may be a HBM device that includes an interface die (or logic die) 204 and one or more memory core dies 206 stacked on the interface die 204. The memory core dies 206 can include DRAM devices/dies, NAND devices/dies, and/or other types of memory devices (e.g., SRAM) as main memory configured to store data provided by the processor 210 and to provide access of the stored data to the processor 210. The memory device 202 can further include additional and/or supplementary memory circuits (e.g., SRAM, DRAM, NAND, etc.), located within and/or outside of the core dies 206, configured for internal uses (e.g., remaining inaccessible to the processor 210). The memory device 202 can include one or more TSVs 208, which may be used to couple the interface die 204 and the core dies 206.

The interposer 212 (e.g., a silicon interposer) can provide electrical connections between the processor 210, the memory device 202, and/or the package substrate 214. For example, the processor 210 and the memory device 202 may both be coupled to the interposer 212 by a number of internal connectors (e.g., micro-bumps 211). The interposer 212 may include channels 205 (e.g., an interfacing or a connecting circuit) that electrically couple the processor 210 and the memory device 202 through the corresponding micro-bumps 211. While three channels 205 are shown in FIG. 2, greater or fewer numbers of channels 205 may be used. The interposer 212 may be coupled to the package substrate by one or more additional connections (e.g., intermediate bumps 213, such as C4 bumps).

The package substrate 214 can provide an external interface for the SiP 200. The package substrate 214 can include external bumps 215, some of which may be coupled to the processor 210, the memory device 202, or both. The package substrate may further include direct access (DA) bumps coupled through the package substrate 214 and interposer 212 to the interface die 204.

Unlike the SiP 100 of FIG. 1A, the SiP 200 can include a memory controller 209 within the memory device 202 instead of the processor 210. For the illustrated example, the interface die 204 can include the memory controller 209. The memory controller 209 can be generally similar to the memory controller 109 of FIG. 1, such as for the overall function. In some embodiments, the memory controller 209 can be different, such as regarding separate write and read circuit paths/connections, and the details of such differences are described further below.

Additionally, to further facilitate the functions of the memory controller 209 within the memory device 202, the memory device 202 can include a circuit interface fabric 250. In some embodiments, the circuit interface fabric 250 can include a DRAM Interface Fabric (DIFF) circuit on the interface die 204. The circuit interface fabric 250 can include circuitry, electrical connections, and/or arrangements thereof configured to facilitate communications between the processor 210 and the core dies 206 through the TSVs 208. Stated differently, the circuit interface fabric 250 can provide the adjustments in the circuitry for implementing the memory controller 209 at the memory device 202.

Since the memory controller 209 is at the memory device 202, communications between the memory device 202 and the processor 210 can utilize more efficient communication format, including communication of compressed data. For the example illustrated in FIG. 2A, the SiP 200 can include a memory-side converter 222 at the memory device 202 and a processor-side converter 224 at the processor 210. The converters can be implemented as hardware circuits, software modules, firmware, or a combination thereof to compress and decompress the data communicated between the devices. Accordingly, the converters can provide improvements in bandwidth and corresponding power/heat metrics for the SiP 200 in comparison to the SiP 100. Details regarding the converters are described below.

### Data Converters and Related Circuits

To further describe the converters, FIG. 2B shows a schematic block diagram of a processor (e.g., the processor 210) and a memory device (e.g., the memory device 202) in accordance with an embodiment of the present technology. In providing context for the converters, the processor 210 can include a physical interface (PHY) circuit 251a, such as transmitters, receivers, signal drivers, and/or the like, configured to facilitate the exchange of electrical signals with the memory device 102. Unlike the PHY 151a of FIG. 1B, the PHY 251a can controlled by the processor 210 (e.g., the logic therein). Differing from the PHY 151a implemented in HBM applications, the PHY 151a can have a device-to-device (D2D) PHY interface configuration (i.e., different from JEDEC HBM configuration). In some embodiments, the D2D PHY 251a can have a custom configuration, including communication of compressed data between the processor 210 and the memory device 202. In other embodiments, the D2D PHY 151a can have a standard configuration (e.g., Universal Chiplet Interconnect Express (UCIe)).

The PHY 251a can be coupled to the memory device 202 and the interface die 204 therein using channels (e.g., the channels 205 of FIG. 2A) or similar connections within the interposer 212 of FIG. 2. The interface die 204 can include a PHY circuit 251b that implements the communications for the memory device 202. Accordingly, the PHY 251b can match or correspond to the PHY 251a. For example, the PHY 251b can be configured according to the D2D PHY interface configuration instead of the JEDEC HBM standards.

The memory controller 209 can be configured to control the communications between the PHY 251b and the circuit interface fabric 250. The memory controller 209 can utilize PHY 251b for communicating with the PHY 251a and utilize the circuit interface fabric 250 for internally communicating with the core dies 206 through core interface 253 (e.g., the TSVs 208 of FIG. 2A).

As described above, the data communicated between the PHY 251a and the 251b can include compressed data. To provide the corresponding compression and decompression of the communicated data, each of the processor 210 and the memory device 202 can include a converter, such as the processor-side converter 224 at the processor 210 and the memory-side converter 222 at the memory device 202.

FIG. 2C illustrates further details of the converters. FIG. 2C is a detailed circuit diagram of data converter circuitry in accordance with an embodiment of the present technology. Each of the converters can include a receiver and a transmitter. The transmitter can selectively compress the payload data for transmission, and the receiver can decompress the received data. For example, the memory-side converter 222 can include a memory receiver 270 and a memory transmitter 280, and the processor-side converter 224 can include a processor transmitter 260 and a processor receiver 290. Each of the transmitters can include a compression circuit (e.g., compression circuits 262 and 282) and a decision circuit (e.g., decision circuits 264 and 284).

The compression circuits can compress the accessed data according to a predetermined compression scheme, such as LZ4 for low latency, high speed and lossless compression. The compression circuits can be configured to compress in blocks of predetermined sizes, such as for 64 Bytes, 128 Bytes, etc.

The decision circuits can determine whether the compression satisfies a minimum compression ratio. For example, the decision circuits can compare the size of original raw data 258 to the size of compressed data 259 (e.g., the result of compressing the original raw data 258). The decision circuits can pass the raw data 258 as payload 257 when the compression ratio fails to meet the threshold but pass the compressed data 259 when the compression ratio is sufficient according to the threshold. In other words, the decision circuits can allow the communication of the compressed data when the compression provides sufficient processing gain to offset the latency caused by the decompression.

Since the payload 257 can include either the raw data 258 or the compressed data 259, the transmitters can generate and send a compression indicator 256 as part of a message 255 that includes the payload 257. The compression indicator 256 can indicate whether the payload 257 within the corresponding message 255 is the raw data 258 or the compressed data 259.

Accordingly, when the receiver (e.g., the receiver 270 or 290) receives the message, the receiver can use a detector (e.g., a detector 272 or 292) to read the compression indicator 256. Based on the compression indicator 256, the detector can selectively (1) enable a decompressor (e.g., decompressor 274 or 294) to decompress the compressed data 259 and recover the corresponding raw data 258 or (2) pass the received payload 257 (i.e., when it is the raw data 258) to a multiplexor (e.g., a multiplexor 276 or 296). The multiplexor can pass the received raw data to the downstream circuits, such as the processor cores or the memory core dies (e.g., through the memory controller 209, the DIFF 250, and the TSVs 253).

As an illustrative example, the processor 210 can access (via, e.g., the process transmitter 260) write data intended to be stored at the memory device 202 of FIG. 2B. The write data can correspond to the raw data 258 for the write operation. The compression circuit 262 can generate the compressed data 259 corresponding to the write data. The decision circuit 264 can compare the raw write data to the compressed write data to determine the compression ratio. The decision circuit 264 can include the raw data 258 in the payload 257 when the compression ratio is insufficient according to the threshold ratio (e.g., 1.1 or greater, such as 1.4, 1.5, 2.0, etc.). When the compression ratio is sufficient, the decision circuit 264 can include the compressed data 259 in the payload 257. Moreover, the decision circuit 264 can generate the compression indicator 256 the reflects the type of data included in the payload 257. The decision circuit 264 can provide the corresponding message 255 to the PHY 251a, and the PHY 251a can send the message 255 to the memory device 202 for storage.

At the memory device 202, the PHY 251b can receive the message 255 and pass the received message 255 to the memory receiver 270. The detector 272 within the memory receiver 270 can evaluate the compression indicator 256 to determine the next processing steps. When the indicator 256 indicates that the payload 257 includes the raw data 258, the detector 272 can pass the raw data 258 to the multiplexor 276 and then to the downstream circuits for storage. When the indicator 256 indicates that the payload 257 includes the compressed data 259, the detector 272 can pass the compressed data 259 to the decompressor circuit 274. The decompressor circuit 274 can reverse the compression to recover the raw data 258 from the compressed data 259. The recovered raw data 258 can correspond to the original write data, which can be pass downstream through the multiplexor 276 for storage.

For read operations, the processor 210 can provide the read command to the memory device 202, and the memory device 202 can access the requested data from the commanded address. The stored data can be accessed from the memory core dies through the TSVs 253, the DIFF 250, and the memory controller 209. The accessed read data can correspond to the raw data 258 for the read operations.

The memory transmitter 280 can process the raw data 258 using the compressor 282, thereby generating the compressed data 259. The decision circuit 284 can compare the raw data 258 and the compressed data 259 and generate the message 255 (e.g., a read response) as described above. The PHY 251b can send the message 255 to the processor 210 in response to the read command.

The processor 210 can receive the message 255 through the PHY 251a. The processor receiver 290 can process the received message 255 similar to the memory receiver 270 described above. For example, the detector 292 can implement the decompressor circuit 294 to recover the raw read data 258 when the payload 257 included the compressed data 259. Otherwise, the detector 292 can pass the received raw data 258 to the multiplexor 296. Either way, the multiplexor can receive the raw data 258 that corresponds to the originally accessed read data, and the multiplexor can pass the read data to subsequent circuitry (e.g., core).

### Control Flow

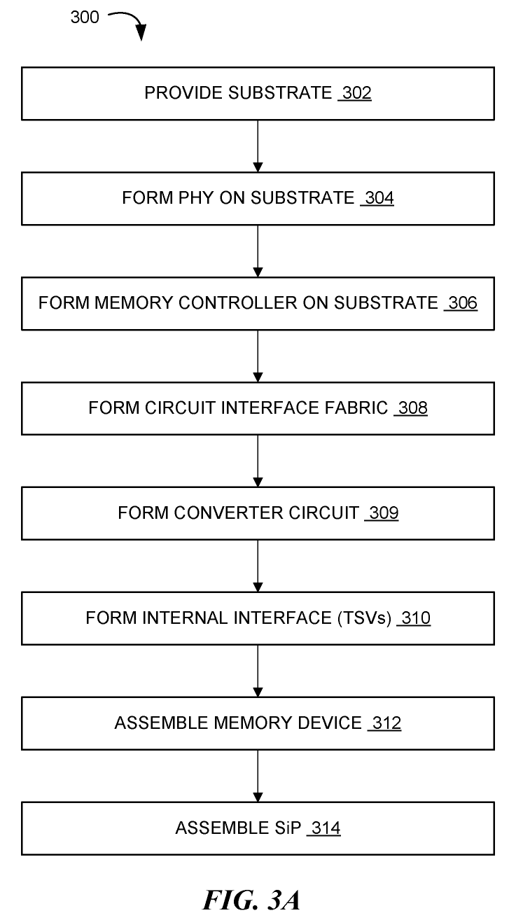

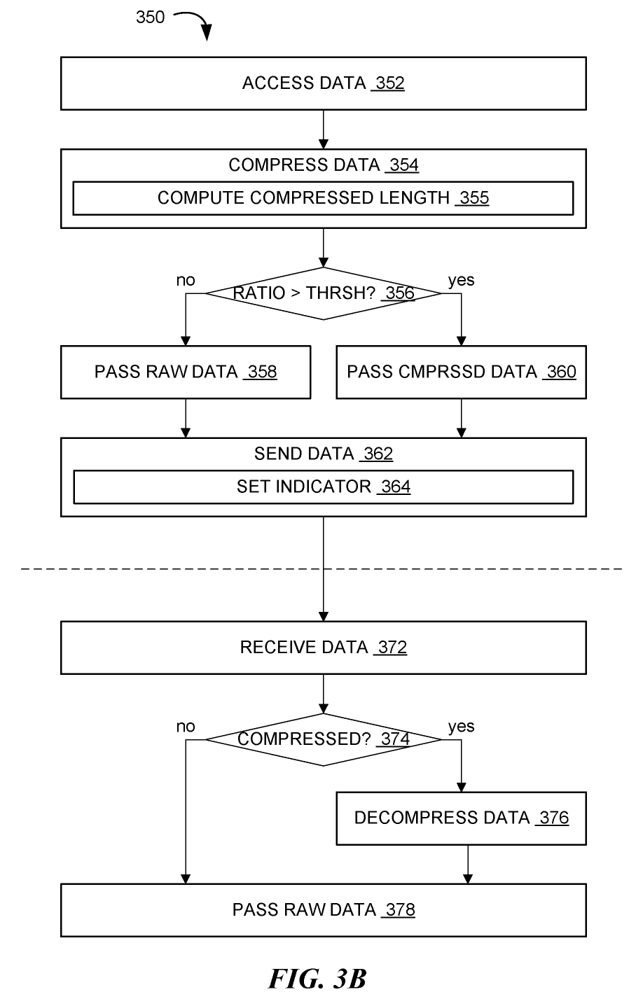

FIG. 3A is a flow diagram illustrating an example method 300 of manufacturing an apparatus (e.g., the SiP 200 of FIG. 2A, the memory device 202 of FIG. 2A, and/or the interface die 204 of FIG. 2A,) in accordance with an embodiment of the present technology. The method 300 can include manufacturing the circuit interface fabric 250 of FIG. 2A, the memory controller 209 of FIG. 2A, the converter, or a combination thereof on the interface die 204 and/or a corresponding device or SiP.

At block 302, the method 300 can include providing a semiconductor substrate, such as a semiconductor wafer. The semiconductor wafer can be processed to form functional circuitry thereon, such as active components, passive components, electrical connections, power components, and/or the like. At block 304, the method 300 can include forming the PHY 251b configured to communicate signals with an externally located processor (e.g., the processor 210 of FIG. 2A) for implementing writes to locations in the core dies 206 of FIG. 2A and reads from the locations in the dies 206. As described above, the formed PHY 251b can have a D2D communication configuration that is different from the JEDEC HBM requirements for communications between the PHY 151a of FIG. 1B and the PHY 151b of FIG. 1B.

At block 306, the method 300 can include forming a memory controller circuit (e.g., the memory controller 209) coupled to the PHY and configured to control and manage flow of data between the processor and memory cells. The memory controller 209 can have dedicated read connections and corresponding circuit paths separate from dedicated write connections/circuit paths.

At block 308, the method 300 can include forming a circuit interface fabric (e.g., the circuit interface fabric 250) connected to the memory controller. Forming the circuit interface fabric can include forming the die-internal connections 279 of FIG. 2C. Accordingly, the method 300 can include forming a WDQ bus, a RDQ bus 285, and the connection for a CLK. The WDQ bus and the RDQ bus can each be unidirectional for communicating the write data and the read data, respectively.

The WDQ bus and the RDQ bus can each have the bus width that is greater than that of the JEDEC HBM bidirectional DQ standardized bus width. For example, the bus width can be 33 bit width or greater (e.g., 256 bit width). Further, the circuit interface fabric 250 can utilize the communication speed that is less than the standardized communication speed for the JEDEC HBM communication. For example, the communication speed can be less than 12 Gbps (e.g., 1.5Gbps) for communicating data with the memory controller 209.

To facilitate the WDQ bus and the RDQ bus, the circuit interface fabric 250 can be formed with the set of write receiver circuits and the set of set of read transmitter circuits. Such circuits can be configured to operate directly based on the CLK without adjusting/aligning with the WDQS. Accordingly, the circuit interface fabric 250 can be formed without synchronizing FFs 186 of FIG. 1C.

At block 309, the method 300 can include forming a data converter circuit (e.g., the converter 222 of FIG. 2C) coupled to the PHY and memory controller. The data converter circuit can be configured to selectively convert data into compressed and uncompressed formats for communication with the processor. Forming the data converter circuit can include forming a memory receiver (e.g., the memory-side receiver 270 of FIG. 2C) and a memory transmitter (e.g., the memory-side transmitter 280 of FIG. 2C). As described above, the memory receiver can include (1) a compression detector configured to detect if received data is compressed, (2) a decompressor configured to decompress received data, and/or (3) a multiplexor configured to select between compressed and raw data. Also, as described above, the memory transmitter can include (1) a compressor configured to compress data and/or (2) a decision circuit configured to determine whether to use compressed data based on programmable thresholds.

At block 310, the method 300 can include forming TSVs (e.g., the TSVs 208 of FIG. 2A as an example of the core interface 253 of FIG. 2B) connected to the circuit interface fabric. The TSVs can be formed coupling the WDQ connection point and the RDQ connection point to the core dies 206 having the memory cells and stacked on the HBM interface die 204. The TSVs can be directly connected to the write receiver circuits 290 and the read transmitter circuits 295 without intervening circuitry (e.g., the synchronizing FFs 186).

At block 312, the method 300 can include assembling a memory device (e.g., the memory device 202) using the processed substrate. The memory device can be formed by stacking the memory dies 206 over the interface die 204. In some embodiments, the memory device can be formed by stacking and bonding the wafers (e.g., the wafers having the memory circuits over the wafer having the interface circuits) and then singluating the wafer stack to form the singulated die stacks.

At block 314, the method 300 can include assembling a SiP or a portion thereof using the memory device. For example, the method 300 can include attaching the memory device 202 over the interposer 212 of FIG. 2A, mounting the processor 210 over the interposer 212, mounting the interposer 212 over the package substrate 214 of FIG. 2A, or a combination thereof.

FIG. 3B is a flow diagram illustrating an example method 350 of operating an apparatus (e.g., the SiP 200 of FIG. 2A, the memory device 202 of FIG. 2A, the interface die 204 of FIG. 2A, etc.) in accordance with an embodiment of the present technology. The method 350 can be for operating the circuit interface fabric 250 of FIG. 2A, the memory controller 209 of FIG. 2A, the converter, or a combination thereof internal to the interface die 204.

The method 350 can include accessing the target payload data as shown in block 352. Using the example illustrated in FIG. 2C, the target payload data can include the raw data 258 of FIG. 2C, which can include the write data sourced at the processor 210 of FIG. 2C for write operations or the read data sourced at the memory device 202 of FIG. 2B. For the read operation example, the memory device can obtain the data values stored at the address accompanying the read command from the processor 210. The read data can be accessed at the interface die 204 through the TSVs 253, the DIFF 250, and the memory controller 209, all shown in the example illustrated in FIG. 2C.

In transmitting the data, the method 350 can include compressing the accessed data as shown in block 354. The accessed data may be compressed using compression techniques, such as LZ4 or other similar techniques. Depending on the transmitting device, the compression circuit 262 or 282 of FIG. 2C can compress the raw data 258 to generate the compressed data 259 of FIG. 2C. The compression circuit can further determine a compressed length (e.g., a length, a size, a number of bits, etc. for the compressed result), such as illustrated at block 355.

At decision block 356, the method 350 can include determining whether the compression ratio (e.g., the ratio between the sizes of the raw data 258 and the compressed data 259) is less than a threshold value as described above. Effectively, the decision circuit 264 or 284 of FIG. 2C can determine whether the compressed data 259 sufficiently reduced the size of the raw data 258. When the compression ratio is not greater than the threshold (e.g., the compression failed to reduce the data length by at least the threshold limit), the method 350 can include passing the raw data 258 as shown at block 358. Otherwise, when compression ratio is greater than the threshold (e.g., the compression successfully reduced the data length by at least the threshold limit), the method 350 can include passing the raw data 258 as shown at block 360. The decision circuit 264 or 284 can pass the selected data to the PHY 251a or 251b of FIG. 2C.

At block 362, the method 350 can include sending the data, using the applicable PHY, to the recipient device. For the write operation, the PHY 251a can send the message 255 of FIG. 2C to the memory device 202. For the read operation, the PHY 251b can send the message 255 to the processor 210. In sending the data, the PHY and/or the decision circuit can set the compression indicator 256 of FIG. 2C according to the selection of raw or compressed data. The compression indicator 256 can be included in the sent message 255.

At block 372, the method 350 can include receiving the sent message 255 at the complementing device. For the write operation, the memory device 202 can receive the message 255 through the PHY 251b. For the read operation, the processor 210 can receive the message 255 through the PHY 251a.

At decision block 374, the method 350 can include determining whether the received message 255 includes the raw data 258 or the compressed data 259 as the payload 257. For the determination, the receiving device can use the detection circuit 272 or 292 of FIG. 2C to read or identify the value of the compression indicator 256.

If the payload 257 includes the compressed data 259, decompress the received data as shown in block 376. For example, upon identifying that the compression indicator 256 indicates compressed data within the payload, the detection circuit 272 can pass the compressed data 259 to the decompressor circuit 274 or 294 of FIG. 2C. The decompressor circuit 274 can reverse the compression and recover the raw data 258 from the compressed data 259. The decompressor circuit 274 can pass the raw data 258 to the multiplexor 276 or 296 of FIG. 2C. Otherwise, when the payload includes the raw data 258, the detection circuit 272 can pass the raw data 258 to the multiplexor 276 or 296. Thus, regardless of the type of data within the payload 257, the multiplexor will pass the raw data 258 to the downstream circuit as shown at block 378.

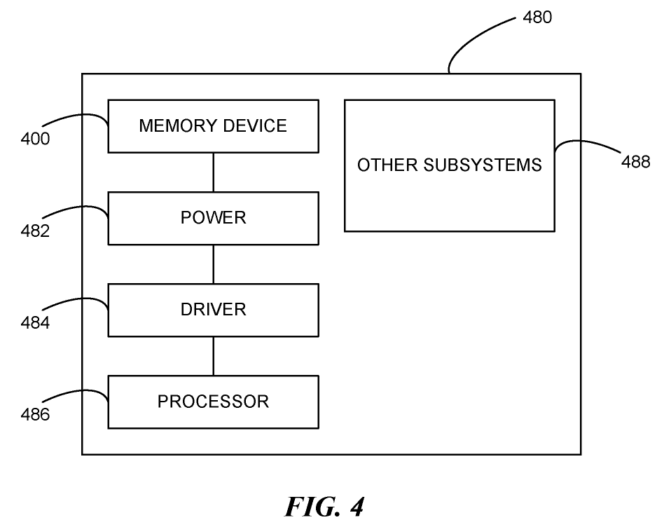

FIG. 4 is a schematic view of a system that includes an apparatus in accordance with embodiments of the present technology. Any one of the foregoing apparatuses (e.g., memory devices) described above with reference to FIGS. 2A- 3B can be incorporated into any of a myriad of larger and/or more complex systems, a representative example of which is system 480 shown schematically in FIG. 4. The system 480 can include a memory device 400, a power source 482, a driver 484, a processor 486, and/or other subsystems or components 488. The memory device 400 can include features generally similar to those of the apparatus described above with reference to FIGS. 2A- 3B, and can therefore include various features for performing a direct read request from a host device. The resulting system 480 can perform any of a wide variety of functions, such as memory storage, data processing, and/or other suitable functions. Accordingly, representative systems 480 can include, without limitation, hand-held devices (e.g., mobile phones, tablets, digital readers, and digital audio players), computers, vehicles, appliances and other products. Components of the system 480 may be housed in a single unit or distributed over multiple, interconnected units (e.g., through a communications network). The components of the system 480 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of DRAM devices. Apparatuses configured in accordance with other embodiments of the present technology, however, can include other types of suitable storage media in addition to or in lieu of DRAM devices, such as, devices incorporating NAND-based or NOR-based non-volatile storage media (e.g., NAND flash), magnetic storage media, phase-change storage media, ferroelectric storage media, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or implementation occurring during operation, usage or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to FIGS. 2A-4.

I/We claim:

1. A High-Bandwidth Memory (HBM) interface die configured to be stacked with one or more core memory dies, the HBM interface die comprising:
a physical layer interface circuit (PHY) configured to communicate a message with a processor for implementing a write operation to a location in the core memory dies or a read operation from the location in the memory dies;
a set of Through Silicon Vias (TSVs) communicatively coupled to the PHY and configured to provide vertical communicative connections to the core memory dies;
a memory controller located between and coupled to the PHY and the TSVs within the interface die, the memory controller configured to control and manage flow of data associated with the message between the processor and the core memory dies for the read and write operations;
a circuit interface fabric connecting the memory controller to the TSVs, the circuit interface fabric connected using a set of dedicated write data connections (WDQ) and a set of dedicated read DQ connections (RDQ) respectively configured for communicating the data between the memory controller and the core memory dies through the TSVs; and
a data converter circuit coupled to the PHY and the memory controller and configured to selectively convert the data into compressed and/or uncompressed formats for communication with the processor.

2. The HBM interface die of claim 1, wherein:
the PHY is configured to receive the message including the data in the compressed format as a payload for the write operation; and
the data converter circuit includes a decompressor circuit configured to decompress the payload to generate a raw data for storage at the location.

3. The HBM interface die of claim 2, wherein the data converter circuit includes a detection circuit configured to:
identify that the payload includes the compressed data based on a compression indicator within the message; and
pass the compressed data to the decompressor circuit for recovering the raw data.

4. The HBM interface die of claim 1, wherein:
the data is a raw read result corresponding to a read operation; and
the converter circuit includes a compressor circuit configured to compress the read result to generate a compressed data.

5. The HBM interface die of claim 4, wherein the converter circuit includes a decision circuit configured to:
compute a compression ratio based on comparing the raw read result to the compressed data; and
select the compressed data for inclusion in the message when the compression ratio satisfies a predetermined compression threshold.

6. The HBM interface die of claim 5, wherein the decision circuit, the PHY, or a combination thereof is configured to determine a compression indicator included in the message, wherein the compression indicator identifies that a payload in the message is in the compressed format.

7. The HBM interface die of claim 6, wherein the PHY is configured to send the message including the compressed data and the compression indicator as a response to the processor for the read operation.

8. A High-Bandwidth Memory (HBM) device comprising:
at least one core die configured to store data; and
an interface die stacked and communicatively coupled with the core die, the interface die including:
a memory controller configured to control and manage flow of data between a processor and the core dies; and
a data converter circuit coupled to the memory controller and configured to selectively convert the data into compressed and/or uncompressed formats for communication with the processor.

9. The HBM device of claim 8, wherein the data converter circuit is configured to:
the interface die is configured to receive the data in the compressed format for a write operation; and
the data converter circuit is configured to decompress the data to generate a raw data for storage at a location identified for the write operation.

10. The HBM device of claim 9, wherein:
the data comprises a payload portion of a message that further includes a compression indicator; and
the data converter circuit is configured to:
identify that the data is in the compressed format based on the compression indicator within the message; and
recovering the raw data from the payload according to the compression indicator.

11. The HBM device of claim 8, wherein:
the data is a raw read result in the uncompressed format corresponding to a read operation; and
the data converter circuit is configured to compress the read result to generate a compressed data for sending to the processor.

12. The HBM device of claim 11, wherein data converter circuit is configured to:
compute a compression ratio based on comparing the raw read result to the compressed data; and
select the compressed data to send to the processor when the compression ratio satisfies a predetermined compression threshold.

13. The HBM device of claim 12, wherein the interface die includes a physical layer circuit (PHY) configured to send a message to the processor, wherein the message includes (1) the compressed data for a payload and (2) a compression indicator identifying that the payload is in the compressed format.

14. A method of operating a High-Bandwidth Memory (HBM) device, the method comprising:
accessing raw read data in response to a read command from an external host device;
compressing the raw read data to generate compressed data; and
sending the compressed data to the external host device as a response to the read command.

15. The method of claim 14, further comprising:
computing a read ratio based on comparing the raw read data and the compressed data, wherein the compressed data is sent when the read ratio satisfies a compression threshold.

16. The method of claim 15, wherein sending the compressed data includes sending a message that having the compressed data as a payload, wherein the message further includes a compression indicator that identifies that the payload is in a compressed format.

17. The method of claim 14, further comprising:
receiving a message from the external host device for a write operation, wherein the message includes a payload; and
decompressing the payload to generate a raw data; and
storing the raw data for the write operation.

18. The method of claim 17, further comprising:
determining that a compression indicator within the message indicates that the payload is in a compressed format, wherein the payload is decompressed according to the compression indicator.

19. The method of claim 14, further comprising:
receiving a message from the external host device for a write operation, wherein the message includes a payload and a compression indicator that identifies whether the payload is in a compressed format or a raw format; and
storing the payload for the write operation without decompressing the payload when the compression indicator identifies that the payload is in the raw format.
